(19) United States
(12) Patent Application Publication
(10) Pub. No.: US 2023/0406777 A1
(43) Pub. Date: Dec. 21, 2023

(54) HEXAGONAL BORON NITRIDE POWDER AND METHOD FOR PRODUCING SINTERED BODY

(71) Applicant: Denka Company Limited, Chuo-ku, Tokyo (JP)

(72) Inventor: Ryuki MATSUI, Tokyo (JP)

(73) Assignee: Denka Company Limited, Chuo-ku, Tokyo (JP)

(21) Appl. No.: 18/246,819

(22) PCT Filed: Sep. 27, 2021
(86) PCT No.: PCT/JP2021/035446

§ 371 Date: Mar. 27, 2023

(30) Foreign Application Priority Data
Sep. 30, 2020 (JP) 2020-165647

(51) Int. Cl. C04B 35/583; C04B 41/00

(52) U.S. Cl. CPC C04B 35/583; C04B 41/0072; C04B 2235/386; C04B 2235/602; C04B 2235/5409; C04B 2235/5436

(57) ABSTRACT

One aspect of the present disclosure provides a hexagonal boron nitride powder including: primary particles of hexagonal boron nitride, in which the number of colored particles containing carbon is 50 or less per 10 g of the hexagonal boron nitride powder.

### TECHNICAL FIELD

The present disclosure relates to a hexagonal boron nitride powder and a method for producing a sintered body.

### BACKGROUND ART

Hexagonal boron nitride has excellent lubricity, a high thermal conductivity, and insulation properties. For this reason, hexagonal boron nitride is used in various applications such as a filler for heat dissipation materials, a solid lubricant, a release material for molten gas, aluminum, and the like, a raw material for cosmetics, and a raw material for sintered bodies.

For example, Patent Literature 1 proposes a hexagonal boron nitride powder and a production method for the same that can increase a thermal conductivity and withstand voltage (dielectric breakdown voltage) of a resin or the like in a case where hexagonal boron nitride is used as a filler for insulation heat dissipation materials such as the above-described resin.

A hexagonal boron nitride powder can be produced, for example, through a method for firing a mixture of a boron compound such as boric acid and a nitrogen-containing compound such as melamine, a method for firing a mixture of a boron compound such as boron oxide and a reducing substance such as carbon in a nitrogen-containing atmosphere, and a method for firing boron carbide in a nitrogen-containing atmosphere.

### CITATION LIST

### Patent Literature

[Patent Literature 1] Japanese Unexamined Patent Publication No. 2019-116401

### SUMMARY OF INVENTION

### Technical Problem

According to the studies of the present inventors, the hexagonal boron nitride obtained through the above-described production method using a raw material containing carbon may contain foreign matter such as colored particles containing carbon, and the colored particles may have conductivity. In recent years, in applications that require high functionality (for example, high insulation properties), further improvements are also required for the hexagonal boron nitride powder serving as a raw material, and it is also desirable that the number of colored particles as described above be reduced. Furthermore, a sintered body obtained by sintering a raw material containing hexagonal boron nitride containing the above-described colored particles may have black spots if the colored particles are present on the surface thereof. From the viewpoint of improving the appearance of the sintered body, it is desirable to reduce the number of colored particles described above.

An object of the present disclosure is to provide a boron nitride powder suitable for high performance applications. Another object of the present disclosure is to provide a boron nitride powder capable of producing a boron nitride sintered body with an excellent appearance.

### Solution to Problem

One aspect of the present disclosure provides a hexagonal boron nitride powder including: primary particles of hexagonal boron nitride, in which the number of colored particles containing carbon is 50 or less per 10 g of the hexagonal boron nitride powder.

In the above-described hexagonal boron nitride powder, the number of colored particles containing carbon has been sufficiently reduced, and the decrease in insulation properties is sufficiently suppressed. In addition, since the number of colored particles has been sufficiently reduced in the above-described hexagonal boron nitride powder, it is suitable for high performance applications. In addition, a sintered body prepared using the powder may have an excellent appearance.

The average particle diameter of the above-described primary particles may be 1 μm or more.

One aspect of the present disclosure is to provide a method for producing a sintered body, the method including: a step of molding a raw material powder containing the above-described hexagonal boron nitride powder to obtain a molded product; and a step of heating and firing the above-described molded product to obtain a sintered body.

Since the raw material powder containing the above-described hexagonal boron nitride powder is used in the method for producing a sintered body, an obtained sintered body may have an excellent appearance.

### Advantageous Effects of Invention

According to the present disclosure, it is possible to provide a boron nitride powder suitable for high performance applications. According to the present disclosure, it is also possible to provide a boron nitride powder capable of producing a boron nitride sintered body with an excellent appearance.

### BRIEF DESCRIPTION OF DRAWINGS

FIG. 1 is a photomicrograph showing an example of a hexagonal boron nitride powder, and is an enlarged photograph in which a portion where colored particles are present is enlarged.

### DESCRIPTION OF EMBODIMENTS

Hereinafter, embodiments of the present disclosure will be described. However, the following embodiments are merely examples for describing the present disclosure and are not intended to limit the present disclosure to the following contents.

The materials exemplified in present specification can be used singly or in combination of two or more thereof unless otherwise specified. The content of each component in a composition means a total amount of multiple substances present in the composition unless otherwise specified in a case where there are multiple substances corresponding to the components in the composition. “Steps” in the present specification may be steps independent of each other or steps performed simultaneously.

<Hexagonal Boron Nitride Powder>

One embodiment of a hexagonal boron nitride powder includes: primary particles of hexagonal boron nitride, in which the number of colored particles containing carbon is 50 or less per 10 g of the hexagonal boron nitride powder. Since the proportion of the colored particles is sufficiently reduced in this manner, the hexagonal boron nitride powder may exhibit excellent functions even in applications that require high levels of insulation properties, a thermal conductivity, and the like. That is, the hexagonal boron nitride powder is suitable for high performance applications. The above-described colored particles are conductive compounds. The color of the above-described colored particles means that the color is different from that of colorless hexagonal boron nitride particles, and does not specify the color. Although particles containing carbon are usually brown or black, the color may vary depending on the content of carbon.

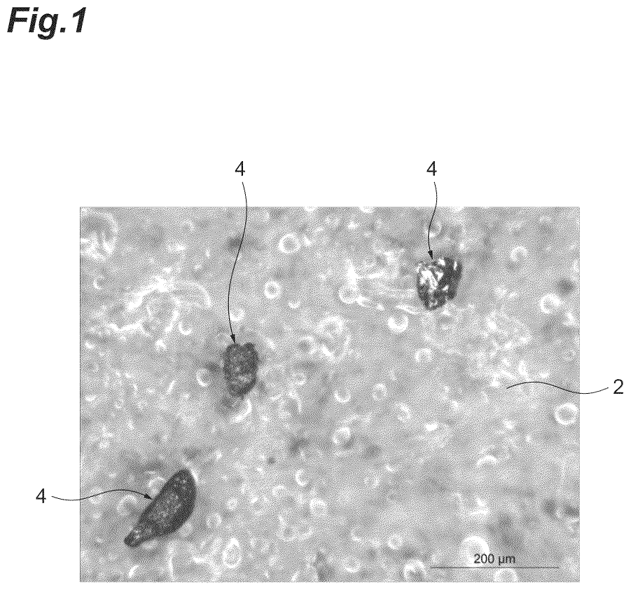

FIG. 1 is a photomicrograph showing an example of a hexagonal boron nitride powder, and is an enlarged photograph in which a portion where colored particles are present is enlarged. In FIG. 1, colorless hexagonal boron nitride 2 and black colored particles 4 which have been mixed into the hexagonal boron nitride 2 can be confirmed. The above-described colored particles are, for example, carbon compounds such as amorphous carbon and graphite. The presence of carbon can be confirmed through measurement with an energy dispersive X-ray analyzer (EDX). The above-described colored particles usually have a relatively large particle diameter. Among the colored particles, those with a larger particle diameter are more likely to affect physical properties of a hexagonal boron nitride powder than those with a smaller particle diameter. The above-described colored particles may include, for example, those with a particle diameter of 63 μm or more.

The number of the above-described colored particles containing carbon is 50 per 10 g of a hexagonal boron nitride powder, and may be, for example, 0.1 to 50, 0.1 to 40, 0.1 to 30, 0.1 to 20, or 0.1 to 10. The hexagonal boron nitride powder may not contain colored particles.

The number of the above-described colored particles in a hexagonal boron nitride powder in the present specification means a value determined as follows. First, 100 mL of ethanol and 10 g of a hexagonal boron nitride powder to be measured are weighed into a container, and stirred with a stirring rod to prepare a mixed solution. Next, a dispersion liquid is prepared from the above-described mixed solution using an ultrasonic disperser. The obtained dispersion is sieved through a sieve with a mesh size of 63 μm (JIS Z 8801-1:2019 “Test Sieve —Metal Mesh Sieve”), and a residue on the sieve (over-size product) is washed with ethanol. Furthermore, the over-size product is transferred to a container, 100 mL of ethanol is added thereto, and stirring, dispersion, and sieving are performed in the same manner as in the above-described operation. The same operation is repeated until the ethanol solution which has passed through the sieve until the ethanol solution is no longer cloudy. Thereafter, over-size product is dried and observed with an optical microscope to count the number of colored particles. The same operation is performed for 10 samples, an arithmetic average of the number of the obtained colored particles is calculated, and the average value is taken as the number of colored particles per 10 g of a hexagonal boron nitride powder.

The average particle diameter (median diameter, D50) of primary particles of a hexagonal boron nitride powder may be, for example, 1 μm or more, 1 to 30 m, 2 to 25 μm, 4 to 20 μm, or 7 to 20 μm. If the average particle diameter of primary particles is within the above-described ranges, a sintered body formed using a hexagonal boron nitride powder can become denser.

The average particle diameter of primary particles in the present specification is measured using a particle size distribution analyzer according to ISO 13320:2009. The average particle diameter obtained through the above-described measurement is an average particle diameter by volume statistics, and the average particle diameter is the median diameter (D50). When measuring the particle size distribution, water is used as a solvent for dispersing the aggregate and hexametaphosphoric acid is used as a dispersing agent. At this time, a numerical value of 1.33 is used for a refractive index of water and a numerical value of 1.80 is used for a refractive index of a hexagonal boron nitride powder. As the particle size distribution analyzer, “MT3300EX” (product name) manufactured by Nikkiso Co., Ltd. and the like can be used, for example.

<Method for Producing Hexagonal Boron Nitride Powder>

The above-described hexagonal boron nitride powder can be produced, for example, by applying a method for firing a mixture of a boron compound such as boric acid and a nitrogen-containing compound such as melamine (especially when boric acid and melamine are used, the method is also referred to as a melamine borate method), a method for firing a mixture of a boron compound such as boron oxide and a reducing substance such as carbon in a nitrogen-containing atmosphere (a so-called carbon reduction method), a method for firing boron carbide in a nitrogen-containing atmosphere (hereinafter also referred to as, for example, a B₄C method), and the like. Hereinafter, the above-described three production methods will be sequentially described.

[Production Method in which Melamine Borate Method is Applied]

One embodiment of the method for producing hexagonal boron nitride powder in which a melamine borate method is applied includes: a step (calcination step) of firing a raw material composition containing a boron-containing compound containing boric acid and a nitrogen-containing compound containing melamine in an atmosphere containing at least one of an inert gas and ammonia gas at 600° C. to 1,300° C. to obtain a calcined product containing at least one selected from the group consisting of low crystalline boron nitride and amorphous boron nitride; a step (firing step) of firing a powder mixture containing the calcined product, boric acid, and an aid in an atmosphere containing at least one of an inert gas and ammonia gas at a temperature of 1,600° C. or higher and lower than 1,900° C. to obtain a fired product; a step (pulverization step) of obtaining a powder by pulverizing the above-described fired product and adjusting the particle size; and a step (annealing step) of heating the above-described powder in an atmosphere containing at least one of an inert gas and ammonia gas at a temperature of 1,900° C. or higher. The above-described firing step may be repeated plural times (hereinafter sequentially referred to as a first firing step, a second firing step, and the like). In the case where the firing step is repeated plural times, fired products obtained in each firing step may be pulverized. By pulverizing the fired products, melamine and the like in a raw material composition in the firing steps after the second firing step can be sufficiently consumed. In addition, the pulverization step may also include washing and drying the powder obtained through the pulverization to obtain a dry powder.

A boron-containing compound is a compound containing boron atoms as constituent elements. A boron-containing compound may further contain, for example, boron oxide and sodium borate in addition to boric acid. A nitrogen-containing compound is a compound containing nitrogen atoms as constituent elements, and may be an organic compound. A nitrogen-containing compound may further contain, for example, dicyandiamide and urea in addition to melamine. The raw material composition may contain components other than the above-described compounds. The raw material composition may contain carbonates such as lithium carbonate and sodium carbonate as an calcination aid. In addition, the raw material composition may contain a reducing substance such as carbon.

In the above-described raw material composition, the formulation ratio of the boron-containing compound and the nitrogen-containing compound may be prepared based on the molar ratio of boron atoms and nitrogen atoms, and the compounds may be formulated so that the molar ratio of the boron atoms and the nitrogen atoms becomes 2:8 to 8:2 or 3:7 to 7:3.

In the calcination step, the above-described raw material composition is calcined, for example, using an electric furnace to obtain a calcined product. The calcination step is performed in an atmosphere containing at least one of an inert gas and ammonia gas. Examples of inert gas include nitrogen gas and a noble gas. The noble gas may be, for example, helium gas and argon gas. The calcination step may be performed in a mixed gas atmosphere in which an inert gas is mixed with ammonia gas. The calcination temperature may be, for example, 600° C. to 1,300° C., 800° C. to 1,200° C., or 900° C. to 1,100° C. The calcination time may be, for example, 0.5 to 5 hours or 1 to 4 hours.

The calcined product obtained through calcining may contain at least one selected from the group consisting of low crystalline boron nitride and amorphous boron nitride, and may further include hexagonal boron nitride. In the calcination step, the reaction of boron nitride is allowed to progress at a lower temperature than in the firing step to be described below. Grain growth can be suppressed by lowering the calcination temperature, and the average particle diameter of a hexagonal boron nitride powder finally obtained can be reduced. In addition, grain growth can be suppressed by lowering the calcination temperature, and the specific surface area of a hexagonal boron nitride powder can be increased.

Next, in the firing step, the calcined product obtained as described above, boric acid, and an aid are formulated and mixed with each other to prepare a powder mixture, which is then fired. In the firing step, production and crystallization of boron nitride are allowed to progress in the presence of boric acid and the aid while sufficiently consuming the raw material composition. As a result, the crystallinity of the boron nitride contained in the calcined product can be enhanced to form hexagonal boron nitride. In the firing step, by additionally adding boric acid thereto, melamine in the raw material composition and amorphous carbon, graphite, and the like generated by the reaction of the raw material composition can be sufficiently reacted and the content thereof can be reduced, whereby the amount of colored particles in the obtained hexagonal boron nitride powder can be further reduced.

The lower limit value of the content of boric acid in the powder mixture may be, for example, 1 part by mass or more, 5 parts by mass or more, or 10 parts by mass or more based on 100 parts by mass of the calcined product. By setting the lower limit value of the content of boric acid to be within the above-described ranges, the amount of residual melamine and the like can be more sufficiently reduced, and the number of colored particles containing carbon can be further reduced. The upper limit value of the content of boric acid in the powder mixture may be, for example, 30 parts by mass or less, 20 parts by mass or less, or 15 parts by mass or less based on 100 parts by mass of the calcined product. By setting the upper limit value of the content of boric acid to be within the above-described ranges, the number of colored particles can be reduced, and a hexagonal boron nitride powder with a small amount of residual boric acid can be obtained. The content of boric acid may be set to be within the above-described ranges, and may be, for example, 1 to 30 parts by mass, 10 to 30 parts by mass, 10 to 20 parts by mass, or 1 to 15 parts by mass based on 100 parts by mass of the calcined product.

Examples of aids include borates such as sodium carbonate and carbonates such as sodium carbonate, calcium carbonate, and lithium carbonate. The formulation amount of the aid may be 2 to 20 parts by mass or 2 to 8 parts by mass based on 100 parts by mass of the calcined product containing boron nitride.

The powder mixture in the firing step is fired using, for example, an electric furnace to obtain a fired product. The firing step is performed in an atmosphere containing at least one of an inert gas and ammonia gas. Examples of inert gas include nitrogen gas and a noble gas. The noble gas may be, for example, helium gas and argon gas. The firing step may be performed in a mixed gas atmosphere containing an inert gas and ammonia gas.

The firing temperature is 1,600° C. or higher and lower than 1,900° C. This firing temperature may be 1,650° C. to 1,850° C. or 1,650° C. to 1,750° C. The firing time may be, for example, 0.5 to 5 hours or 1 to 4 hours.

The firing time, heating time, and the like in the present specification mean the time (holding time) for maintaining the temperature of the surrounding environment of an object after the temperature reaches a predetermined temperature.

By keeping the firing temperature relatively high, the consumption of the raw material composition, the consumption of amorphous carbon and graphite produced by the reaction of the raw material composition, and the production and crystallization of hexagonal boron nitride can be sufficiently advanced. By reducing the amount of raw material containing carbon such as melamine in the raw material composition, the number of colored particles in a hexagonal boron nitride powder obtained can be reduced, and the quality can be further improved. The same trend is observed even if the firing time is lengthened. On the other hand, if the firing temperature is too high, the crystal growth of hexagonal boron nitride proceeds too much, which tends to make fine pulverization difficult. The same trend is observed even when the firing time is too long.

For the pulverization of the fired product obtained in the firing step, a pulverizer or the like may be used, for example. For the pulverizer, an impact type pulverizer or the like may be used, for example. As the impact type pulverizer, one capable of adjusting the particle size of a pulverized product with a screen such as an impact-type screen-type fine pulverizer can be suitably used, for example. The mesh size of a screen may be, for example, 0.1 to 1 mm or 1 to 3 mm.

In the pulverization step, the above-described fired product is pulverized to adjust the particle size. Adjusting the particle size can improve the efficiency of the subsequent annealing step. The pulverized powder obtained through the pulverization of the fired product may contain impurities in addition to hexagonal boron nitride. Therefore, a treatment (refining treatment) for reducing the impurities may be performed before the annealing step. Examples of impurities include residual raw materials and aids, and water-soluble boron compounds. The refining treatment reduces the amount of such impurities, for example, through washing. After washing, solid-liquid separation and drying are performed to obtain a dry powder.

Examples of washing liquids used for washing include an aqueous solution containing water and an acidic substance, an organic solvent, and a mixed liquid of an organic solvent and water. From the viewpoint of avoiding secondary contamination of impurities, water having an electric conductivity of 1 mS/m or less may be used. Examples of acidic substances include inorganic acids such as hydrochloric acid and nitric acid. Examples of organic solvents include water-soluble organic solvents such as methanol, ethanol, propanol, isopropyl alcohol, and acetone. The washing method is not particularly limited. For example, the pulverized powder may be immersed in a washing liquid and stirred and washed, or the pulverized powder may be washed by spraying a washing liquid.

After the completion of washing, the washing liquid may be subjected to solid-liquid separation through decantation or using a suction filter, a pressure filter, a rotary filter, a sedimentation separator, or a combination thereof. A dry powder may be obtained by drying the separated solid content in a usual dryer. Examples of dryers include a shelf-type dryer, a fluidized bed dryer, a spray dryer, a rotary-type dryer, a belt-type dryer, and a combination thereof. After drying, for example, classification with a sieve may be performed to remove coarse particles.

In the annealing step, the dry powder or pulverized product of the fired product is heated, for example, using an electric furnace or the like. The annealing step is performed in an atmosphere containing at least one of an inert gas and ammonia gas. Examples of inert gas include nitrogen gas and a noble gas. The noble gas may be, for example, helium gas and argon gas. The calcination step may be performed in a mixed gas atmosphere containing an inert gas and ammonia gas. The temperature for the heat treatment in the annealing step is 1,900° C. or higher, and may be 1,950° C. or higher or 2,000° C. or higher from the viewpoint of sufficiently reducing the amount of oxygen. By performing the annealing step, oxygen present as functional groups or the like on the surface of particles can be dispersed to reduce the amount of oxygen. Through the pulverization step before the annealing step, a powder or dry powder with a lower content of an aid and the like than the fired product can be prepared and then annealed to reduce the amount of oxygen while suppressing grain growth.

From the viewpoint of suppressing the grain growth, the temperature for the heat treatment in the annealing step may be 2,200° C. or less or 2,100° C. or less. The heating time in the annealing step may be, for example, 0.5 to 5 hours or 1 to 4 hours from the viewpoints of sufficiently reducing the amount of oxygen and suppressing the grain growth.

The number of colored particles has been sufficiently reduced in the hexagonal boron nitride powder obtained through the above-described production method in which the melamine borate method is applied. The average particle diameter of the hexagonal boron nitride powder obtained through the above-described production method can be set to, 1 to 30 μm, 3 to 20 μm, or 5 to 15 μm.

The BET specific surface area of the hexagonal boron nitride powder obtained through the above-described production method can be set to, for example, 0.5 to 30 m²/g, 1 to 20 m²/g, or 2 to 10 m²/g. When the BET specific surface area is within the above-described ranges, releasability, lubricity, and a thermal conductivity are excellent.

The specific surface area of the hexagonal boron nitride powder in the present specification is measured with a measurement device according to JIS Z 8803:2013. The specific surface area is a value calculated by applying a BET single-point method in which nitrogen gas is used.

[Production Method in which Carbon Reduction Method is Applied]

One embodiment of the method for producing hexagonal boron nitride powder in which a carbon reduction method is applied includes: a low-temperature firing step of heating a raw material composition containing a boron-containing compound containing boric acid and a carbon-containing compound in a gas atmosphere containing a nitrogen-containing compound under a pressure of 0.25 MPa or higher and lower than 5.0 MPa at a temperature of 1,600° C. or higher to obtain a first heat-treated product; a firing step of heating the first heat-treated product at a temperature higher than that in the above-described low-temperature firing step and lower than 1,850° C. to obtain a second heat-treated product; and a high-temperature firing step of firing the above-described second heat-treated product at a temperature higher than that in the above-described firing step to obtain a hexagonal boron nitride powder. In the above-described production method, the content of the boron-containing compound is 350 parts by mass or more based on 100 parts by mass of the carbon-containing compound.

The low-temperature firing step is a step of pressurizing and heating a raw material composition in the presence of a nitrogen-containing compound to produce boron nitride. The raw material composition contains a boron-containing compound and a carbon-containing compound.

A boron-containing compound is a compound containing boron as a constituent element. The boron-containing compound is a compound that reacts with a carbon-containing compound and a nitrogen-containing compound to form boron nitride. As the boron-containing compound, a relatively inexpensive high-purity raw material can be used. Examples of such boron-containing compounds include boron oxide in addition to boric acid. The boron-containing compound includes boric acid, which is dehydrated by heating to form boron oxide, which can form a liquid phase during the heat treatment of the raw material composition and can also serve as an aid for promoting grain growth. In addition, boric acid can be easily removed out of the system through heating in a low-pressure environment.

A carbon-containing compound is a compound containing carbon atoms as constituent elements. The carbon-containing compound reacts with a boron-containing compound and a nitrogen-containing compound to form boron nitride. As the carbon-containing compound, a relatively inexpensive high-purity raw material can be used. Examples of such carbon-containing compounds include carbon black and acetylene black.

The boron-containing compound is formulated in the raw material composition in an excess amount with respect to the carbon-containing compound. The content of the boron-containing compound in the raw material composition may be, for example, 350 to 1000 parts by mass, 400 to 800 parts by mass, 450 to 700 parts by mass, or 450 to 600 parts by mass based on 100 parts by mass of the carbon-containing compound. By incorporating an excess amount of the boron-containing compound into the raw material composition and performing a heat treatment, the carbon-containing compound can be sufficiently reacted and the content thereof can be reduced, whereby the amount of colored particles in the obtained hexagonal boron nitride powder can be further reduced.

The above-described production method may include, for example, a step of preparing a raw material composition. The step of preparing a raw material composition may include a step of dehydrating a boron-containing compound. If the step of preparing a raw material composition includes the step of dehydrating a boron-containing compound, the yield of boron nitride obtained in the low-temperature firing step can be improved. In addition, in the step of preparing a raw material composition, from the viewpoints of mixing raw materials with each other more uniformly and performing a reaction through heating of the raw material composition in a more homogeneous environment, pulverizing and mixing using an impact type pulverizer or the like may be performed. The conditions of the pulverizing and mixing may be the same as those of the pulverization of a fired product in the production method in which the above-described melamine borate method is applied.

The raw material composition may contain other compounds in addition to the carbon-containing compound and the boron-containing compound. Examples of other compounds include boron nitride as a nucleating agent. The average particle diameter of a hexagonal boron nitride powder synthesized can be more easily controlled by incorporating boron nitride as an nucleating agent into the raw material composition. The raw material composition preferably contains a nucleating agent. In the case where the raw material composition contains a nucleating agent, a hexagonal boron nitride powder with a small specific surface area (for example, a hexagonal boron nitride powder with a specific surface area less than 2.0 m²/g) is more easily produced.

In a case where a boron nitride powder is used as a nucleating agent, the content of the above-described nucleating agent may be, for example, 0.05 to 8 parts by mass based on 100 parts by mass of the raw material composition. By setting the lower limit value of the content of the above-described nucleating agent to be 0.05 parts by mass or more, the effect of the incorporation of the nucleating agent can be further improved. By setting the upper limit value of the content of the above-described nucleating agent to 8 parts by mass or less, the yield of a hexagonal boron nitride powder can be improved.

The nitrogen-containing compound is a compound which contains nitrogen atoms and reacts with a carbon-containing compound and a boron-containing compound to form boron nitride. Examples of nitrogen-containing compounds include nitrogen and ammonia. The nitrogen-containing compound may be supplied in the form of a gas, and in this case, the nitrogen-containing compound is also called nitrogen-containing gas. The nitrogen-containing gas preferably contains nitrogen gas or more preferably contains nitrogen gas from the viewpoints of promoting the formation of boron nitride due to the nitridation reaction and reducing costs. In a case where a mixed gas of a plurality of gases is used as nitrogen-containing gas, the proportion of nitrogen gas in the mixed gas may preferably be 95 volume/volume % or higher. The proportion of the above-described nitrogen gas means a value determined by volume in a standard state.

The low-temperature firing step is performed under pressure. The pressure in the low-temperature firing step may be, for example, 0.25 MPa or higher and lower than 5.0 MPa, 0.25 to 3.0 MPa, 0.25 to 2.0 MPa, 0.25 to 1.0 MPa, 0.25 MPa or higher and lower than 1.0 MPa, 0.30 to 2.0 MPa, or 0.50 to 2.0 MPa. By increasing the pressure in the low-temperature firing step, volatilization of the raw materials such as a boron-containing compound can be further suppressed and formation of boron carbide which is a by-product can be suppressed. In addition, by increasing the pressure in the low-temperature firing step, an increase in the specific surface area of the boron nitride powder can be suppressed. By setting the upper limit value of the pressure in the low-temperature firing step to be within the above-described ranges, the growth of the boron nitride primary particles can be further promoted.

The low-temperature firing step is performed under heating. The heating temperature in the low-temperature firing step may be, for example, 1,650° C. or higher and lower than 1,800° C., 1,650° C. to 1,750° C., or 1,650° C. to 1,700° C. By setting the lower limit value of the heating temperature in the low-temperature firing step to be within the above-described ranges, a reaction can be promoted and the yield of the boron nitride obtained in the low-temperature firing step can be improved. By setting the upper limit value of the heating temperature in the low-temperature firing step to be within the above-described ranges, the production of a by-product can be sufficiently suppressed. In the low-temperature firing step, the heating rate is not particularly limited, but may be, for example, 0.5° C./min or higher.

The heating time in the low-temperature firing step may be, for example, 1 to 10 hours, 1 to 5 hours, or 2 to 4 hours. In the low-temperature firing step, which is a beginning of a reaction for synthesizing boron nitride, by maintaining the temperature at a relatively low temperature for a predetermined period of time, the reaction system can be made more homogeneous, and thus the boron nitride formed in the low-temperature firing step can be further homogenized.

The firing step is a step of further heating a first heat-treated product obtained in the low-temperature firing step at a temperature higher than that in the low-temperature firing step to obtain a second heat-treated product. In this step, the growth of crystal grains can be promoted and an aid in the reaction system can be more sufficiently consumed.

The heating temperature in the firing step is higher than that in the low-temperature firing step and is lower than 1,850° C. The firing step may be performed continuously with the low-temperature firing step, and the conditions other than the temperature in the low-temperature firing step may be maintained. That is, the low-temperature firing step may also be a step of heating a first heat-treated product in a pressurized environment containing nitrogen-containing gas or the like.

The heating time in the firing step may be, for example, 3 to 15 hours, 5 to 10 hours, or 6 to 9 hours.

The high-temperature firing step is a step of firing the second heat-treated product obtained in the firing step at a higher temperature to obtain a hexagonal boron nitride powder. In the high-temperature firing step, the crystallinity of boron nitride is obtained, and primary particles of hexagonal boron nitride are obtained. The primary particles of hexagonal boron nitride have a scaly shape. Furthermore, by setting the heating temperature in this step high, the residual amount of aid or the like can be reduced and the purity can be further improved, whereby an obtained hexagonal boron nitride powder is more suitable as a raw material for a sintered body.

The pressure in the high-temperature firing step may be the same as or different from those in the low-temperature firing step and the firing step. In a case where the pressure in the high-temperature firing step is different from those in the low-temperature firing step and the firing step, it may be lower than those in the low-temperature firing step and the firing step.

The pressure in the high-temperature firing step may be, for example, 0.25 MPa or higher and lower than 5.0 MPa, 0.25 to 3.0 MPa, 0.25 to 2.0 MPa, 0.25 to 1.0 MPa, 0.25 MPa or higher and lower than 1.0 MPa, 0.30 to 2.0 MPa, or 0.50 to 2.0 MPa. By setting the pressure in the high-temperature firing step high, the purity of an obtained hexagonal boron nitride powder can be further improved. By setting the upper limit value of the pressure in the high-temperature firing step to be within the above-described ranges, production costs of a hexagonal boron nitride powder can be further reduced, which is industrially advantageous.

The firing temperature in the high-temperature firing step is set to a temperature higher than the heating temperature in the above-described firing step. The firing temperature in the high-temperature firing step may be, for example, 1,850° C. to 2,100° C., 1,850° C. to 2,050° C., or 1,900° C. to 2,025° C. By increasing the firing temperature in the high-temperature firing step, the purity of a hexagonal boron nitride powder can be further improved and the growth of primary particles can be promoted, whereby the specific surface area of a hexagonal boron nitride powder can be further reduced. By setting the upper limit value of the firing temperature in the high-temperature firing step to be within the above-described ranges, yellowing of hexagonal boron nitride can be suppressed.

The firing time (heating time at a high temperature) in the high-temperature firing step may be, for example, 0.5 to 30 hours, 1 to 25 hours, or 3 to 10 hours. By setting the firing time in the high-temperature firing step to be within the above-described ranges, the purity of a hexagonal boron nitride powder can be further improved and the growth of primary particles can be grown more sufficiently. By setting the firing time in the high-temperature firing step to be within the above-described ranges, a hexagonal boron nitride powder can be produced at low cost.

The above-described production method may have other steps in addition to the low-temperature firing step, the firing step, and the high-temperature firing step. Examples of other steps include the above-described step of preparing a raw material composition and step of dehydrating a raw material composition, a step of pressurizing and molding a raw material composition, a step of pulverizing first and second heat-treated products, and a step of pulverizing hexagonal boron nitride. In a case where the above-described production method includes the step of pressurizing and molding a raw material composition, firing can be performed in an environment in which the raw material composition is present at high density and the yield of boron nitride obtained in the low-temperature firing step and the firing step can be further improved. The pulverization step in the present specification also includes disintegration in addition to pulverization.

As the pulverization conditions, the conditions described in the production method in which the above-described melamine borate method is applied can be used.

The number of colored particles has been sufficiently reduced in the hexagonal boron nitride powder obtained through the above-described production method in which the carbon reduction method is applied. The average particle diameter of the hexagonal boron nitride powder obtained through the above-described production method in which the carbon reduction method is applied can be set to, 1 to 30 μm, 3 to 20 μm, or 5 to 15 μm.

The BET specific surface area of the hexagonal boron nitride powder obtained through the above-described production method can be set to, for example, 0.5 to 30 m²/g, 0.8 to 20 m²/g, or 1 to 10 m²/g. When the BET specific surface area is within the above-described ranges, releasability, lubricity, and a thermal conductivity are excellent.

[Production Method in which B₄C Method is Applied]

One embodiment of the method for producing hexagonal boron nitride powder in which a B₄C method is applied includes: a step (nitriding step) of firing a boron carbide powder in a nitrogen pressurized atmosphere to obtain a fired product containing boron carbonitride; and a step (crystallization step) of heating a powder mixture which contains the fired product and a boron-containing compound containing boric acid to produce scaly boron nitride primary particles and obtaining a boron nitride powder containing agglomerated particles obtained by aggregating the primary particles. In the above-described production method, the content of the boron-containing compound is 50 parts by mass or more based on 100 parts by mass of the boron carbonitride powder.

The boron carbide powder can be prepared, for example, according to the following procedure. After mixing boric acid with acetylene black, the mixture is heated at 1,800° C. to 2,400° C. for 1 to 10 hours in an inert gas atmosphere to obtain a boron carbide mass. After this boron carbide mass is pulverized, it can be sieved, and washing, removal of impurities, drying, and the like can be appropriately performed to prepare a boron carbide powder. Here, the boron carbide powder having the above-described aspect ratio can be obtained, for example, by performing pulverization under relatively mild conditions and then performing a combination of classification using a vibration sieve and airflow classification. Specifically, the boron carbide powder may be obtained by removing particles having a size greater than or equal to a predetermined size using a vibration sieve and removing particles having a size less than or equal to a predetermined size through airflow classification.

In the nitriding step, a boron carbide powder is fired in a nitrogen pressurized atmosphere to obtain a fired product containing boron carbonitride (B₄CN₄). The firing temperature in the nitriding step may be, for example, 1,800° C. to 2,400° C., 1,900° C. to 2,400° C., 1,800° C. to 2,200° C., or 1,900° C. to 2,200° C.

The pressure in the nitriding step may be 0.6 to 1.0 MPa, 0.7 to 1.0 MPa, 0.6 to 0.9 MPa, or 0.7 to 0.9 MPa. By setting the lower limit value of the pressure to be within the above-described ranges, the nitridation of boron carbide can be more sufficiently advanced. On the other hand, if the pressure is too high, there is a trend for production costs to increase.

The concentration of nitrogen gas in a nitrogen pressurized atmosphere in the nitriding step may be 95 volume % or more or 99.9 volume % or more. The firing time in the nitriding step is not particularly limited as long as nitriding sufficiently proceeds, and may be, for example, 6 to 30 hours or may be 8 to 20 hours.

In the crystallization step, a formulation that contains a boron-containing compound and the fired product containing boron carbonitride obtained in the nitriding step is heated to produce scaly boron nitride primary particles, and a boron nitride powder containing agglomerated particles obtained by aggregating the primary particles are obtained. That is, in the crystallization step, a boron carbonitride is decarbonized and scaly primary particles having a predetermined size are produced, and these are aggregated to obtain a boron nitride powder containing the agglomerated particles.

Examples of boron-containing compounds include boron oxide in addition to boric acid. The powder mixture heated in the crystallization step may contain well-known additives.

The formulation ratio of boron carbonitride with respect to the boron-containing compound in the powder mixture can be appropriately set according to the molar ratio. The content of the boron-containing compound in the powder mixture may be, for example, 50 to 300 parts by mass, 100 to 300 parts by mass, 100 to 250 parts by mass, or 150 to 250 parts by mass based on 100 parts by mass of the boron carbonitride. By incorporating an excess amount of the boron-containing compound into the boron carbonitride and performing a heat treatment, the boron carbonitride and an unreacted part of boron carbide can be sufficiently reacted and the content thereof can be reduced, whereby the amount of colored particles in the obtained hexagonal boron nitride powder can be further reduced.

The heating temperature for heating the powder mixture in the crystallization step may be, for example, 1,800° C. to 2,200° C., 2,000° C. to 2,200° C., or 2,000° C. to 2,100° C. By setting the heating temperature to be within the above-described ranges, the particle growth can be more sufficiently advanced. In the crystallization step, heating may be performed in a normal pressure (atmospheric pressure) atmosphere or may be performed at a pressure exceeding the atmospheric pressure through pressurization. In a case of pressurization, the pressure may be, for example, 0.5 MPa or lower or 0.3 MPa or lower.

The heating time in the crystallization step may be, for example, 0.5 to 40 hours, 0.5 to 35 hours, or 1 to 30 hours. If the heating time is too short, there is a trend for grain growth to insufficiently proceed. On the other hand, if the heating time is too long, there is a trend for the step to be industrially disadvantageous.

A hexagonal boron nitride powder can be obtained through the above-described steps. A pulverization step may be performed after the crystallization step. In the pulverization step, a usual pulverizer or disintegrator can be used. For example, a ball mill, a vibration mill, a jet mill, and the like can be used. In the present disclosure, “disintegration” is also included in “pulverization”. The average particle diameter of a hexagonal boron nitride powder may be adjusted to 15 to 200 μm through pulverization and classification.

<Method for Producing Sintered Body>

One embodiment of the method for producing a sintered body includes: a step of molding a raw material powder containing the above-described hexagonal boron nitride powder to obtain a molded product; and a step of heating and firing the above-described molded product to obtain a sintered body. In the step of obtaining the above-described molded product, a slurry containing the above-described powder and a binder may be prepared, and the slurry may be molded after being spheroidized using a spray dryer or the like. By using the powder granulated by the spheroidizing treatment, the density of the molded product can be improved and the structure of the sintered body can be made denser. For molding, a mold may be used, or a cold isostatic pressing method (CIP).

The powder for obtaining a molded product in the method for producing a sintered body may contain, for example, an amorphous boron nitride powder, other nitrides, and a sintering aid in addition to the hexagonal boron nitride powder. Other nitrides may contain, for example, at least one nitride selected from the group consisting of aluminum nitride and silicon nitride. The above-described powder preferably contains a hexagonal boron nitride powder and an amorphous boron nitride powder and more preferably does not contain other nitrides.

The sintering aid may be, for example, oxides of rare earth elements such as yttrium oxide, oxides such as alumina oxide and magnesium oxide, alkali metal carbonates such as lithium carbonate and sodium carbonate, and boric acid. In a case of incorporating a sintering aid, the amount of sintering aid added may be, for example, 0.01 parts by mass or more or 0.1 parts by mass or more based on 100 parts by mass in total of, for example, a hexagonal boron nitride powder, an amorphous boron nitride powder, and the sintering aid. The amount of sintering aid added may be, for example, 20 parts by mass or less, 15 parts by mass or less, or 10 parts by mass or less based on 100 parts by mass in total of a hexagonal boron nitride powder, an amorphous boron nitride powder, and the sintering aid.

The lower limit value of the sintering temperature of a molded product may be, for example, 1,600° C. or higher or 1,700° C. or higher. The upper limit value of the sintering temperature of a molded product may be, for example, 2,200° C. or lower or 2,000° C. or lower. The sintering time of a molded product may be, for example, 1 hour or longer or 3 hours or longer, or may be 30 hours or shorter or 10 hours or shorter. The atmosphere during sintering may be, for example, an inert gas atmosphere such as nitrogen, helium, and argon.

A batch type furnace and a continuous type furnace can be used for sintering. Examples of batch type furnaces include a muffle furnace, a tubular furnace, and an atmospheric furnace. Examples of continuous type furnaces include a rotary kiln, a screw conveyor furnace, a tunnel furnace, a belt furnace, a pusher furnace, and a koto-shaped continuous furnace.

Some embodiments have been described above, but the present disclosure is not limited to any of the above-described embodiments. In addition, the contents of the description of the above-described embodiments can be applied to each other.

### EXAMPLES

Hereinafter, the contents of the present disclosure will be described in more detail with reference to examples and comparative examples. However, the present disclosure is not limited to the following examples.

### Example 1

[Preparation of Hexagonal Boron Nitride Powder: Production Method in which Melamine Borate Method is Applied]

### <Calcination Step>

100.0 parts by mass of a boric acid powder (purity of 99.8 mass % or more, manufactured by Kanto Chemical Co., Inc.) and 90.0 parts by mass of a melamine powder (purity of 99.0 or more, manufactured by Wako Pure Chemical Industries, Ltd.) were mixed with each other with an alumina mortar for 10 minutes to obtain a mixed raw material. The mixed raw material after drying was placed in a container made of hexagonal boron nitride and placed in an electric furnace. The temperature was raised from room temperature to 1,000° C. at a rate of 10° C./min while circulating nitrogen gas in the electric furnace. After holding the temperature at 1,000° C. for 2 hours, the heating was stopped and the mixture was allowed to cool naturally. The electric furnace was open at a point in time when the temperature became 100° C. or lower. In this manner, a calcined product containing low crystalline hexagonal boron nitride was obtained.

<Firing Step>

20 parts by mass of boric acid and 3.0 parts by mass of sodium carbonate (purity of 99.5 mass % or more) as an aid were added to 100.0 parts by mass of the calcined product and mixed with each other with an alumina mortar for 10 minutes. The mixture was placed in the above-described electric furnace. The temperature was raised from room temperature to 1,700° C. at a rate of 10° C./min while circulating nitrogen gas in the electric furnace. After holding the temperature at a firing temperature of 1,700° C. for 4 hours, the heating was stopped and the mixture was allowed to cool naturally. The electric furnace was open at a point in time when the temperature became 100° C. or lower. The obtained fired product was collected and pulverized with alumina mortar for 3 minutes to obtain a coarse powder of hexagonal boron nitride.

<Purification Process>

In order to remove impurities contained in a coarse powder of hexagonal boron nitride, 30 parts by mass of the coarse powder was put into 500 parts by mass (concentration of nitric acid: 5 mass %) of dilute nitric acid and stirred at room temperature for 60 minutes. After stirring, solid-liquid separation was performed through suction filtration, and washing was performed by replacing the liquid with water (electric conductivity: 1 mS/m) until the filtrate became neutral. After washing, the solid was dried with a dryer at 120° C. for 3 hours to obtain a dry powder.

<Annealing Step>

The dry powder was placed in the above-described electric furnace. The temperature was raised from room temperature to 2,000° C. at a rate of 10° C./min while circulating nitrogen gas in the electric furnace. After holding the temperature at 2,000° C. for 4 hours, the heating was stopped and the mixture was allowed to cool naturally. The electric furnace was open at a point in time when the temperature became 100° C. or lower. The obtained fired product was collected and pulverized in an alumina mortar for 3 minutes, and a coarse powder was removed from the obtained dry powder using an ultrasonic vibrating sieve (manufactured by Kowa Kogyosho Co., Ltd., trade name: KFS-1000, mesh size of 250 μm) to obtain a hexagonal boron nitride powder of Example 1.

### Comparative Example 1

A hexagonal boron nitride powder was produced in the same manner as in Example 1 except that a powder mixture of a calcined product and an aid was used instead of using boric acid in the firing step.

### Example 2

[Preparation of Hexagonal Boron Nitride Powder: Production Method in which Carbon Reduction Method is Applied]

### <Raw Material Preparation Step>

100 Parts by mass of acetylene black (manufactured by Denka Company Limited, grade name: HS100) and 700 parts by mass of boric acid (manufactured by Kojundo Chemical Laboratory Co., Ltd.) were mixed with each other using a Henschel mixer to obtain a raw material composition. The obtained powder mixture was placed in a dryer at 250° C. and held for 3 hours to dehydrate boric acid. 200 g of the powder mixture after dehydration was placed in a mold of a press molding machine with a diameter of <D 100 and molded under the conditions of a heating temperature of 200° C. and a pressing pressure of 30 MPa. Pellets of the raw material composition obtained in this manner were subjected to a subsequent heat treatment.

<Low-Temperature Firing Step>

First, the above-described pellets were allowed to stand in a carbon atmosphere furnace, the temperature was raised to 1,750° C. at a temperature increase rate of 5° C./min in a nitrogen atmosphere pressurized to 0.8 MPa, and the pellets were heated while holding the temperature at 1,750° C. for 3 hours to obtain a first heat-treated product.

<Firing Step>

Next, the temperature in the carbon atmosphere furnace was further increased to 1,800° C. at a temperature increase rate of 5° C./min, and the first heat-treated product was heated while holding the temperature at 1,800° C. for 7 hours to obtain a second heat-treated product.

<High-Temperature Firing Step>

Thereafter, the temperature in the carbon atmosphere furnace was raised to 2,000° C. at a temperature increase rate of 5° C./min, and the second heat-treated product was fired at a high temperature while holding the temperature at 2,000° C. for 7 hours (third step). Loosely aggregated boron nitride after firing was pulverized with a Henschel mixer and passed through a sieve with a mesh size of 75 μm to obtain a sieved powder. In this manner, a hexagonal boron nitride powder was prepared.

### Example 3

A hexagonal boron nitride powder was prepared in the same manner as in Example 2 except that the content of boric acid was set to 350 parts by mass based on 100 parts by mass of acetylene black.

### Example 4

[Preparation of Hexagonal Boron Nitride Powder: Production Method in which B₄C Method is Applied]

### <Raw Material Preparation Step>

100 Parts by mass of acetylene black (manufactured by Denka Company Limited, grade name: HS100) and 285 parts by mass of orthoboric acid (manufactured by Nippon Denko Co., Ltd.) were mixed with each other using a Henschel mixer. A graphite crucible was filled with the obtained mixture which was then heated at 2,200° C. for 5 hours in an arc furnace in an argon atmosphere to obtain agglomerated boron carbide (B₄C). The obtained agglomerate was coarsely pulverized with a jaw crusher to obtain a coarse powder. This powder was further pulverized with a ball mill having silicon carbide balls ((D 10 mm) to obtain a pulverized powder. The pulverization with a ball mill was performed at a rotation frequency of 20 rpm for 60 minutes. Thereafter, the pulverized powder was classified with a vibration sieve having an opening of 45 μm. A fine powder on the sieve was subjected to airflow classification with a Classiel classifier to obtain a boron carbide powder having a particle diameter of greater than or equal to 10 μm. In this manner, the boron carbide powder obtained had an aspect ratio of 2.5 and an average particle diameter of 30 μm (measurement methods thereof will be described below). The carbon content of the obtained boron carbide powder was 19.9 mass %. The carbon content was measured with a carbon/sulfur simultaneous analyzer.

<Nitriding Step>

A boron nitride crucible was filled with the prepared boron carbide powder. Thereafter, a resistance heating furnace was used to heat the boron carbide powder for 10 hours under the conditions of 2,000° C. and 0.85 MPa in a nitrogen gas atmosphere. In this manner, a fired product containing boron carbonitride (B₄CN₄) was obtained.

<Crystallization Step>

The fired product was formulated with boric acid at a proportion so that the content of boric acid became 300 parts by mass based on 100 parts by mass of boron carbonitride, and the mixture was mixed with a Henschel mixer. A boron nitride crucible was filled with the obtained mixture, and the temperature was raised from room temperature to 1,000° C. at a rate of temperature increase of 10° C./min in a nitrogen gas atmosphere under a pressure condition of 0.2 MPa using a resistance heating furnace. Subsequently, the temperature was raised from 1,000° C. to 2,000° C. at a rate of temperature increase of 2° C./min. By heating the mixture at 2,000° C. and holding it for 6 hours, hexagonal boron nitride containing agglomerated particles obtained by aggregating primary particles was obtained.

The obtained agglomerated boron nitride was disintegrated with a Henschel mixer. Thereafter, the disintegrated powder was classified with a nylon sieve having a sieve opening of 90 μm to obtain a boron nitride powder.

### Comparative Example 2

A hexagonal boron nitride powder was prepared in the same manner as in Example 1 except that the content of boric acid was set to 20 parts by mass based on 100 parts by mass of boron carbonitride.

[Evaluation of Hexagonal Boron Nitride Powder]

For each of the hexagonal boron nitride powders obtained in Examples 1 to 4 and Comparative Examples 1 and 2, the number of colored particles, the average particle diameter, and the specific surface area were measured. The results are shown in Table 1.

[Average Particle Diameter of Boron Nitride Powder]

The average particle diameter of a boron nitride powder was measured with a particle size distribution measuring device (device name: LS-13 320) for a laser diffraction scattering method manufactured by Beckman Coulter Inc. according to the description of ISO 13320:2009. The measurement was performed by subjecting the hexagonal boron nitride powders obtained in Examples 1 to 3 and Comparative Example 1 to a homogenizer treatment, but not subjecting the hexagonal boron nitride powders obtained in Example 4 and Comparative Example 2 to a homogenizer treatment. When measuring the particle size distribution, water was used as a solvent for dispersing each of the boron nitride powders and hexametaphosphoric acid was used as a dispersing agent. At this time, a numerical value of 1.33 was used as a refractive index of water, and a numerical value of 1.80 was used as a refractive index of a boron nitride powder.

[Production and Evaluation of Sintered Body of Hexagonal Boron Nitride]

Sintered bodies were produced through a method described below using the hexagonal boron nitride powders obtained in Examples 1 to 4 and Comparative Examples 1 and 2. That is, 60.0 mass % of each hexagonal boron nitride powder and 40.0 mass % of an amorphous boron nitride powder (manufactured by Denka Company Limited, oxygen content: 1.5%, boron nitride purity: 97.6%, average particle diameter: 6.0 μm) were weighed into a container and mixed to prepare a sintering raw material. A cold isostatic pressing device was filled with the above-described sintering raw material which was then compressed under a pressure of 30 MPa to obtain a molded product (unfired product). The obtained molded product was sintered while holding the temperature at 2,000° C. for 10 hours using a firing furnace to prepare a sintered body of nitride. Firing was performed by adjusting the inside of the furnace to be in a nitrogen atmosphere.

The sintered bodies obtained as described above were visually observed, and the appearance was evaluated according to the following criteria. Specifically, the appearance was confirmed by visually observing the presence or absence of black spots (positions where black particles are present) on both main surfaces of the sintered bodies. The appearance was evaluated from the observation results according to the following criteria. The results are shown in Table 1.
A: No black spots were observed.
B: The number of black spots was 1/cm² or more and less than 3/cm².
C: The number of black spots was 3/cm² or more and less than 5/cm².
D: The number of black spots was 5/cm² or more.

TABLE 1

| | | | Comparative | | | | Comparative |
|---|---|---|---|---|---|---|---|
| | | Example 1 | Example 1 | Example 2 | Example 3 | Example 4 | Example 2 |
| Hexagonal | Number of colored | 1 | 64 | 0 | 45 | 0 | 61 |
| boron nitride | particles [pieces] | | | | | | |
| powder | Average particle | 8 | 6 | 9 | 5 | 38 | 36 |
| | diameter [μm] | | | | | | |
| | Specific surface | 1.8 | 5.2 | 1.3 | 6.3 | 3.0 | 5.6 |
| | area [m²/g] | | | | | | |
| Evaluation | Appearance of | A | D | A | B | A | C |
| | sintered body | | | | | | |

It was confirmed that hexagonal boron nitride powders in which the number of colored particles was reduced could be prepared as described above. It can be stated that the hexagonal boron nitride powders would be suitable for high performance applications. The sintered bodies obtained using the hexagonal boron nitride powders can exhibit excellent insulating properties and appearances.

### INDUSTRIAL APPLICABILITY

According to the present disclosure, it is possible to provide a boron nitride powder which has a reduced content of foreign matter and is suitable for high performance applications. According to the present disclosure, it is also possible to provide a boron nitride powder capable of producing a boron nitride sintered body with an excellent appearance.

### REFERENCE SIGNS LIST

2 Hexagonal boron nitride
4 Colored particles

1. A hexagonal boron nitride powder comprising:
primary particles of hexagonal boron nitride,
wherein the number of colored particles containing carbon is 50 or less per 10 g of the hexagonal boron nitride powder.

2. The hexagonal boron nitride powder according to claim 1,
wherein the primary particles have an average particle diameter of 1 μm or more.

3. A method for producing a sintered body, comprising:
a step of molding a raw material powder containing the hexagonal boron nitride powder according to claim 1 to obtain a molded product; and
a step of heating and firing the molded product to obtain a sintered body.

4. The hexagonal boron nitride powder according to claim 1,
wherein the primary particles have an average particle diameter of 1 to 38 μm.

5. The hexagonal boron nitride powder according to claim 1,
wherein the BET specific surface area of the hexagonal boron nitride powder is 0.5 to 30 m²/g.
